(19) United States
(12) Patent Application Publication
(10) Pub. No.: US 2004/0104999 A1
(43) Pub. Date: Jun. 3, 2004

(54) Electronic endoscope apparatus transmitting radio signals by wire

(75) Inventor: Fujio Okada, Saitama-shi (JP)

Correspondence Address: Ronald R. Snider, P.O. Box 27613, Washington, DC, 20038-7613, US

(73) Assignee: Fuji Photo Optical Co., Ltd., Saitama-shi (JP)

(21) Appl. No.: 10/703,633

(22) Filed: Nov. 10, 2003

(30) Foreign Application Priority Data
Nov. 12, 2002 (JP) 2002-328193

(51) Int. Cl. H04N 7/18; H04N 9/47

(52) U.S. Cl. 348/65

(57) ABSTRACT

A video signal and a control signal are converted into a radio frequency based on a radio communication method. This radio frequency is used to execute wired communications via one coaxial cable provided between a scope and a processor device. Furthermore, an electromagnetic coupling means composed of a primary coil and a secondary coil is provided between a connector and a light source device. The electromagnetic coupling means supplies power to the scope on the basis of electromagnetic induction. It is thus possible to connect the scope to both the processor device and the light source device using only two wires including a ground line. This makes it possible to prevent the inappropriate connection of or possible damage to connection pins or the like.

### BACKGROUND OF THE INVENTION

1. Field of the Invention

This application claims the priority of Japanese Patent Applications No. 2002-328193 filed on Nov. 12, 2002 which is incorporated herein by reference.

The present invention relates to an electronic endoscope apparatus, and in particular, to an arrangement that transmits a video signal and a control signal between an electronic endoscope that picks up an image of an object and an external device such as a processor device, the arrangement also supplying power to the electronic endoscope.

2. Description of the Related Art

In an electronic endoscope apparatus, a CCD (Charge Coupled Device), for example, a solid image pickup element, is mounted in an electronic endoscope. An image pickup signal for an object obtained by the CCD is subjected to video processing by a processor device. Then, this video signal is outputted to a monitor or the like. The video signal and a control signal are transmitted via a cable and a connector that connect the scope and the processor device.

FIG. 4 shows how a cable is connected to a processor device. A processor device 1 is provided not only with a power switch 2 but also with a connector receiver 3 for an electric connection (the connector receiver in the drawing is larger than an actual one). On the other hand, a scope-side cable 4 is provided with a connector plug 5. Signal lines and power lines are connected by coupling the connector plug 5 to the connector receiver 3 of the processor device 1.

However, in the above electronic endoscope apparatus, the cable 4, which connects the scope and the processor device 1 together, contains a large number of signal lines and power lines. For example, the connector 5 of the cable 4 has a multi-pin structure having 50 pins (for example, Japanese Patent Laid-Open No. 7-313454). Accordingly, connection pins in the connector may undergo inappropriate contact or may be damaged. This may increase costs.

Furthermore, if a large number of signal lines and power lines are housed in the cable 4 and connected using the connectors (3, 5), then during transmission, a video signal may be mixed with noise or an unwanted electric wave may be radiated from the connector section to affect other equipment.

Japanese Patent Laid-Open No. 6-335450 and Japanese Patent Laid-Open No. 2002-165756 disclose an electronic endoscope apparatus that enables a scope and a processor to communicate with each other wirelessly.

### SUMMARY OF THE INVENTION

The present invention is provided in view of the above problems. It is an object of the present invention to provide an electronic endoscope apparatus which minimizes the number of cables required to connect electrically an electronic endoscope and an external device such as a processor device together, thus preventing the inappropriate connection of or possible damage to connection pins, and the mixture of noise and reducing the amount of radiated unwanted electric waves.

To accomplish this object, an aspect of the present invention according to claim 1 provides an electronic endoscope apparatus comprising an electronic endoscope provided with an image pickup element that picks up an image of an object and a processor device to which the electronic endoscope is removably connected to execute a process required to display a video on the basis of a signal outputted by the image pickup element, the apparatus being characterized by having radio transmission and reception circuits arranged in the electronic endoscope and the processor device and cooperating in modulating a video signal and a control signal into a radio frequency (a signal in a radio frequency band) based on a predetermined radio communication method and demodulating the radio frequency into the original video signal and control signal, a transmission line that connects the radio transmission and reception circuits of the electronic endoscope and processor device together, and electromagnetic coupling means electromagnetically couple the electronic endoscope to an external device with a power source to supply power to the electronic endoscope on the basis of electromagnetic induction. The external device may be a processor device, a light source, or the like which has a power source.

An aspect of the present invention according to claim 2 is characterized in that a radio antenna is connected to each of the radio transmission and reception circuits.

According to the arrangement in claim 1, the radio transmission and reception circuits of the electronic endoscope and processor device are connected together using a transmission line (wire) composed of, for example, one coaxial cable (or two electric wires including a ground line). The electronic endoscope and for example, a light source device (or a processor device) are electromagnetically coupled to each other by a space transformer. Accordingly, power from the processor device is supplied to the electronic endoscope on the basis of electromagnetic induction without any connection wires. Then, the radio transmission and reception circuits convert a video signal and a control signal into a radio frequency based on a predetermined radio communication method. This radio frequency (electric wave) is transmitted or received by wire via the transmission line. This radio communication method may be any of those for various frequency bands, but Bluetooth, IEEE801. 11 (a, b), or the like may also be used.

With such an arrangement, the electronic endoscope and the external device can be electrically connected together (signal lines and power lines) using, for example, one coaxial cable. This makes the apparatus more reliable in terms of electric connections and favorably eliminates the disadvantages of the conventional multi-pin structure.

### BRIEF DESCRIPTION OF THE DRAWINGS

FIG. 1 is a circuit block diagram showing the configuration of an electronic endoscope apparatus according to an embodiment of the present invention;

FIG. 2 is a diagram showing a specific connection arrangement for devices in the electronic endoscope apparatus according to this embodiment;

FIGS. 3A and 3B are diagrams showing how the electronic endoscope apparatus according to this embodiment is compatible with a conventional scope; and

FIG. 4 is a diagram showing a processor device in a conventional electronic endoscope apparatus and a scope-side cable connector section.

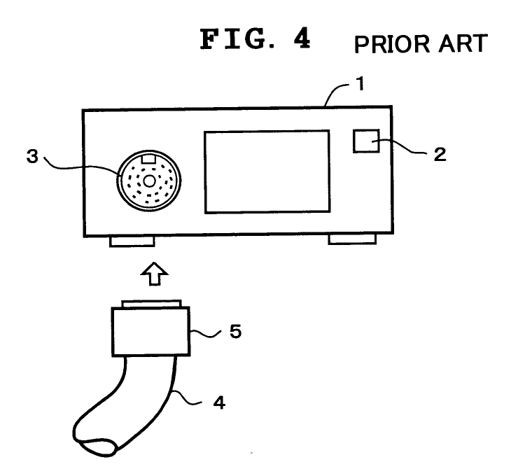

### DETAILED DESCRIPTION OF THE PREFERRED EMBODIMENTS

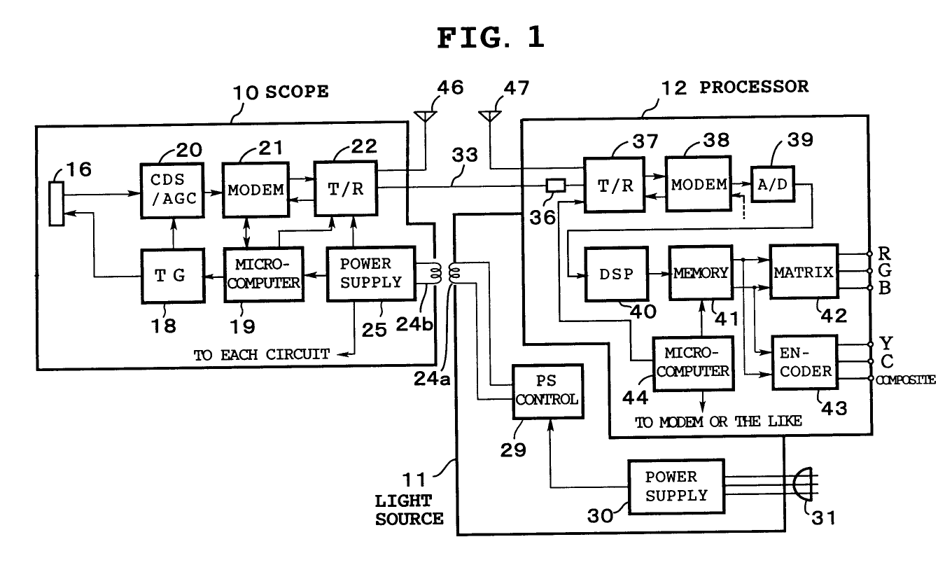

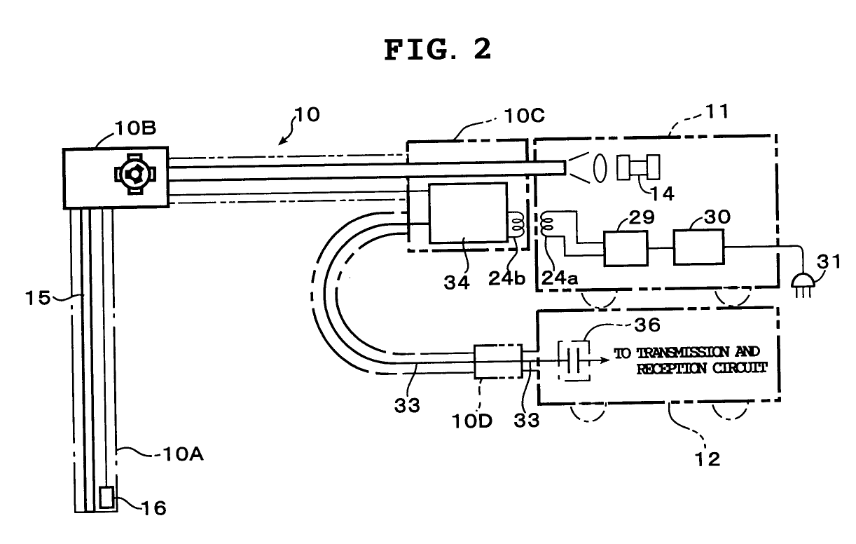

FIGS. 1 and 2 show the configuration of an electronic endoscope apparatus according to an embodiment. As shown in FIG. 2, the electronic endoscope apparatus is composed of a scope (electronic endoscope) 10, a light source device 11, a processor device 12, and the like. The scope 10 has a leading end portion 10A, an operation section 10B, a light source-side connector (section) 10C, and a processor-side connector 10D. The light source-side connector 10C is connected to the light source device 11. The processor-side connector 10D is connected to the processor device 12. A connection portion of a light guide 15 of the light source-side connector 10C is connected to the light source device 11 via an insulating member in order to maintain isolation. The light source device 11 is provided with a light source lamp 14. Light from the lamp 14 is guided to the scope leading end portion 10A via the light guide 15. An object is thus irradiated with the light. The scope leading end portion 10A is provided with a CCD 16 that is a solid image pickup element. The CCD 16 picks up an image of the object on the basis of irradiations with light from the light guide 15.

In FIG. 1, the scope 10 is provided with a timing generator 18 that generates and outputs various timing signals including driving signals for the CCD 16, a microcomputer 19 that controls various circuits in the scope 10, a correlation double sampling/automatic gain control (CDS/AGC) circuit 20 that carries out correlation double sampling and automatic gain control, a modem 21 that carries out modulations and demodulations required to convert (or inversely convert) a video signal and a control signal obtained by the CCD 16 into a radio frequency (band) based on a radio communication method, and a transmission and reception section (T/R) 22 that executes a conversion (up conversion) and an inverse conversion (down conversion) between a modulation frequency and a radio frequency obtained by the modem 21. The modem 21 and the transmission and reception section 22 constitute a transmission and reception circuit.

The radio communication method may be any of those for various frequency bands from 30 MHz to 300 GHz, including short waves, microwaves, and millimeter waves. In recent years, much attention has been paid to Bluetooth, IEEE801. 11 (a, b), and the like utilizing a 2.45 GHz band. These radio communication methods may be used for the present invention.

Furthermore, the scope 10 is provided with a secondary coil 24b constituting electromagnetic coupling means and a power supply circuit 25. The secondary coil 24b is arranged on a surface of the light source-side connector 10C which is closer to the light source device 11, for example, as shown in FIG. 2. On the other hand, a surface of the light source device 11 to which the connector 10C is opposite is provided with a primary coil 24a electromagnetically coupled to the secondary coil 24b. The primary coil 24a and the secondary coil 24b constitute electromagnetic coupling means for supplying power on the basis of electromagnetic induction. Furthermore, as shown in FIG. 1, the primary coil 24a is connected to a power supply circuit 30 via a power supply (PS) control section 29. The power supply circuit 30 is connected to a commercial power source using a plug socket 31.

The scope 10 and the processor device 12 are connected together by one coaxial cable 33. Specifically, the light source-side connector 10C contains a circuit box 34 which has an electric shield around it and in which a part of the circuit in the above described scope 10 is arranged. The one coaxial cable 33 drawn out of the circuit box 34 is connected to the processor device 12 by a processor-side connector 10D.

In FIG. 1, in the processor device 12, the transmission and reception circuit (T/R) 37 and the modem 38 are connected to the coaxial cable 33 via an isolation section (a pulse transformer or an electro-photo conversion circuit) 36. The transmission and reception circuit 37 executes a conversion and an inverse conversion between a modulation frequency and a radio frequency (band). The modem 38 performs modulation and demodulation for converting radio frequency to image signal and control signal (or performing inverse conversion thereof). The transmission and reception circuit composed of the transmission and reception circuit 37 (22) and the modem 38 (21) uses a communication method for a certain frequency band, such as Bluetooth or IEEE801. 11 (a, b). In this case, video signals and control signals are efficiently transmitted on the basis of frequency division modulation (FDM), time division modulation (TDM), or the like.

Furthermore, the processor device 12 is provided with an A/D converter 39 to which outputs from the modem 38 are inputted, a DSP (digital signal processor) circuit 40 which forms video signals such as Y (luminance) signal and a C (color difference) signal and which executes various processes required to form a color video, an image memory 41 used to form still images or for other purposes, a matrix circuit 42 that uses a Y signal and a C signal to form an R (red), G (green), and B (blue) signals for an RGB monitor, an encoder 43 that forms a Y signal, a C signal, and a composite signal for another monitor, and a microcomputer 44 that unitedly controls the above circuits in the processor device 12.

The present embodiment is configured as described above. When the light source device 11 is powered on through the plug socket 31 (the processor device 12 is also powered on), power is supplied to the primary coil 24a via the power supply circuit 30 and the PS control circuit 29. The power is then supplied to the scope-side power supply circuit 25 by the electromagnetic induction between the primary coil 24a and the secondary coil 24b. The power supply circuit 25 forms a predetermined DC power supply required in the scope 10, which is then provided to each circuit.

Then, a driving signal outputted by the timing generator 18 drives the CCD 16, which thus picks up an image of an object. Then, an image pickup signal is supplied to the CDS/AGC circuit 20. The CDS/AGC circuit 20 subjects the image pickup signal to correlation double sampling and amplifies it using a predetermined gain. A video signal obtained is supplied to the modem 21.

The modem 21 modulates the video signal so that it is superimposed on a carrier based on a predetermined radio communication method. The modem 21 then outputs the modulated carrier to the coaxial cable 33 via the transmission and reception circuit 22. Then, in the processor device 12, the transmission and reception circuit 37 receives the radio frequency supplied through the coaxial cable 33 via the isolation section 36. The modem 38 then demodulates the radio frequency to obtain the video signal superimposed on the carrier. Furthermore, a control signal from the scope 10 is similarly transmitted to the processor device 12. The control signal from the processor device 12 is superimposed on a carrier based on the radio communication method, via the modem 38 and the transmission and reception circuit 37. As a result, the control signal is received by the scope 10.

The video signal demodulated by the modem 38 is subjected to predetermined processing by the DSP circuit 40. Then, the signal is outputted by the matrix circuit 42 as R, G, and B signals and also outputted by the encoder 43 as Y (luminance) and C (color difference) signals and the like. These video signals are used to display a video of the object on a monitor or the like.

With the arrangement of this embodiment, a video signal and a control signal are transmitted through one coaxial cable or two wires including the ground. Furthermore, power is supplied on the basis of electromagnetic induction. This makes the apparatus much more reliable in terms of connector connections Compared to the connection of the conventional multi-pin connector, the video signal is prevented from being mixed with noise and the amount of radiated unwanted electric wave is reduced. Specifically, with the conventional multi-pin structure, a video signal, a control signal, or a base band signal for any of various frequencies (fast pulse signal) are transmitted through separate wires (signal lines). However, since these wires extend parallel with one another, the base band signal may be mixed into the video signal or control signal. Furthermore, the base band signal for any of the various frequencies may be radiated as an unwanted electric wave. According to the present invention, the signals are modulated in a radio frequency that is transmitted through the one coaxial cable 33. Consequently, the other wires are not affected and the amount of unwanted radiation is reduced. Moreover, the multi-pin structure requires a complicated shield structure in association with the base band signal for any of the various frequencies. The present invention also simplifies the shield structure.

In this example, between the light source-side connector 10C and the light source device 11, the light guide 15 is connected via the insulating member, and the power source is connected using the electromagnetic coupling means (24a, 24b). Between the processor-side connector 10D and the processor device 12, the transmission line is connected via the isolation section 36. Electric isolation is appropriately maintained between the scope 10 and another device.

Moreover, as shown in FIG. 1, in this embodiment, an antenna 46 can be connected to the transmission and reception circuit 22 of the scope 10, whereas an antenna 47 can be connected to the transmission and reception circuit 37 of the processor device 12. In this case, radio communications can be carried out via the antennas 46 and 47. It is possible to use either antenna radio communications or radio frequency band communications via the coaxial cable 33, or both.

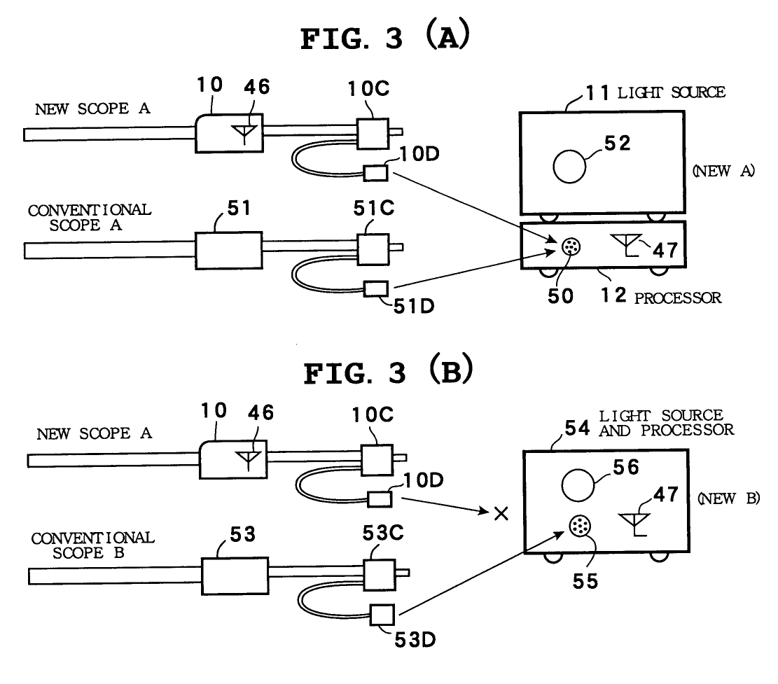

As shown in FIG. 3A and 3B, this example is configured to maintain compatibility with the conventional scope. Specifically, if a radio communication is executed, the connector to the processor device is omitted. However, as shown in FIG. 3A, a connector 51D of a conventional scope 51 can be connected to a connector receiver 50 to which the processor-side connector 10D is connected. Consequently, both the new and conventional scopes 10 and 51 can be connected to the light source device 11 and processor device 12 according to the embodiment. The light source-side connectors (light guides) 10C and 51C are connected to the light source-side connector receiver 52.

Furthermore, in the prior art, there are two types of electronic endoscope apparatuses A and B. These apparatuses are incompatible with each other because their connectors to the processor device have different sizes or the like. If a new apparatus is manufactured as shown in FIGS. 3A and 3B, a light source and processor device 54 into which a light source device and a processor device are integrated is provided with a connector receiver 55 to which a connector 53D of a conventional scope 53 of the type B is connected. However, the connector 10D of the type A cannot be connected to the connector receiver 55. However, since the antennas 46 and 47 are provided to enable radio communications, the new scope 10 of the type A can be connected to the light source and processor device 54 of the type B. Light source-side connectors (light guides) 10C and 53C are connected to a light source-side connector receiver 56.

Alternatively, in the new scope A in FIGS. 3A and 3B, the processor-side connector 10D may be omitted, and if the new scope is used, signal communications are carried out only by radio.

Furthermore, in this example, the electromagnetic coupling means composed of the primary coil 24a and the secondary coil 24b is provided between the scope 10 and the light source device 11. However, the electromagnetic coupling means may be provided between the scope 10 and the processor device 12 or between the scope 10 and another exclusive external power source device.

As described above, according to the present invention, an electronic endoscope apparatus and a processor device are connected together using one coaxial cable. This prevents the inappropriate connection of or possible damage to pins or the like, and reduces manufacturing costs. Moreover, it is possible to prevent the mixture of noise and reduce the amount of radiated unwanted electric waves.

Furthermore, by connecting radio antennas to the above radio transmission and reception circuits, it is advantageously possible to use selectively either antenna radio communications or radio frequency band communications via transmission lines.

What is claimed is:

1. An electronic endoscope apparatus comprising:
an electronic endoscope provided with an image pickup element that picks up an image of an object;
a processor device to which the electronic endoscope is removably connected to execute a process required to display a video on the basis of a signal outputted by said image pickup element;
radio transmission and reception circuits arranged in said electronic endoscope and said processor device, respectively, and cooperating in modulating a video signal and a control signal into a radio frequency based on a predetermined radio communication method and demodulating the radio frequency into the original video signal and control signal;
a transmission line that connects the radio transmission and reception circuits of the electronic endoscope and processor device together; and
electromagnetic coupling means for electromagnetically coupling said electronic endoscope to an external device with a power source to supply power to said electronic endoscope on the basis of electromagnetic induction.

2. The electronic endoscope apparatus according to claim 1, wherein a radio antenna is connected to each of said radio transmission and reception circuits in order to enable signals to be transmitted even by radio.
